(19) United States
(12) Patent Application Publication
(10) Pub. No.: US 2026/0264432 A1
(43) Pub. Date: Sep. 10, 2026

(54) INKJET PRINTING APPARATUS, CONTROL METHOD OF INKJET PRINTING APPARATUS, AND STORAGE MEDIUM

(71) Applicant: CANON KABUSHIKI KAISHA, Tokyo (JP)

(72) Inventors: HIDEHIKO KANDA, Kanagawa (JP); MASATAKA KATO, Kanagawa (JP); KEITA ISHIMI, Kanagawa (JP); JUMPEI JOGO, Tokyo (JP); YUMI SHIMOKODACHI, Kanagawa (JP); TAKAAKI SHIMA, Tokyo (JP)

(21) Appl. No.: 19/532,221

(22) Filed: Feb. 6, 2026

(30) Foreign Application Priority Data
Mar. 4, 2025 (JP) 2025-033841

(51) Int. Cl. B41J 29/393; B41J 2/21; B41J 11/00

(52) U.S. Cl. CPC B41J 29/393; B41J 2/2114; B41J 11/0022; B41J 2029/3935

(57) ABSTRACT

One embodiment of the present invention is an inkjet printing apparatus including: a printing unit configured to print an image by applying a color ink and a reactive liquid to a print medium; and a first setting unit configured to set a reactive liquid amount for a predetermined amount of the color ink. In the inkjet printing apparatus, the printing unit prints a test pattern used to set the reactive liquid amount in the first setting unit, on the print medium of a type selected by a user, based on a print condition set by the user, a plurality of images formed by overlapping images of the color ink and images of the reactive liquid one on top of another are arranged in the test pattern, and the reactive liquid amounts for the respective plurality of images are a plurality of different values for an identical value of a color ink amount.

### BACKGROUND

### Field of the Technology

The present disclosure relates to an inkjet printing apparatus that prints an image by ejecting inks from a print head.

### Description of the Related Art

There is known a printing apparatus that prints an image on a print medium by ejecting inks from a print head to the print medium. Such a printing apparatus are increasingly used to perform printing in various applications, and various types of inks are used to correspond to such usage. Particularly, in recent years, printing apparatuses that can perform printing on a non-absorbent print medium or a low-absorbency print medium are increasing. In the case where these print media are used, a reactive liquid is sometimes used in addition to color inks containing color materials. The reactive liquid causes coagulation of the color materials contained in the color inks by coming into contact with the color inks on the print medium, and is thereby used to suppress bleeding and improve uniformness.

In the printing apparatus that can perform printing on the non-absorbent print medium or the low-absorbency print medium, a print medium with sufficient absorbency is sometimes used. In the case where the print medium with sufficient absorbency is used, there is no need to use the reactive liquid.

Japanese Patent Laid-Open No. 2024-088505 discloses achieving application amount correction that can cause print results to match a target value of an optical density and a target value of gloss in the case where a reactive liquid and color inks containing color materials are applied. Specifically, Japanese Patent Laid-Open No. 2024-088505 discloses that a test pattern in which multiple patches are arranged is printed to correct application amounts of the reactive liquid and the color inks containing the color materials, the multiple patches formed of the reactive liquid and the color inks applied with the application amounts thereof changed at intervals of a predetermined amount.

### SUMMARY

One embodiment of the present disclosure is an inkjet printing apparatus including: a printing unit configured to print an image by applying a color ink and a reactive liquid to a print medium; and a first setting unit configured to set a reactive liquid amount for a predetermined amount of the color ink. In the inkjet printing apparatus, the printing unit prints a test pattern used to set the reactive liquid amount in the first setting unit, on the print medium of a type selected by a user, based on a print condition set by the user, a plurality of images formed by overlapping images of the color ink and images of the reactive liquid one on top of another are arranged in the test pattern, and the reactive liquid amounts for the respective plurality of images are a plurality of different values for an identical value of a color ink amount.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic configuration of an inkjet printing apparatus;

FIG. 2 is a side diagram of the inkjet printing apparatus;

FIG. 3 is a diagram schematically illustrating alignment of ejection ports in a print head;

FIG. 4 is a block diagram illustrating a control configuration of the inkjet printing apparatus;

FIG. 5 is a schematic diagram explaining a multi-pass printing method;

FIG. 6 is a schematic diagram explaining mask patterns;

FIG. 7 is a schematic diagram illustrating a graphical user interface window for selecting a type of print medium;

FIGS. 8A to 8C are explanatory diagrams of wettability of print media;

FIG. 9 is a distribution diagram of absorbency and wettability (contact angle) of the print media;

FIG. 10 is a diagram illustrating print operations selectable in the case where a vinyl chloride film is selected;

FIG. 11 is a diagram illustrating a print condition in a first embodiment;

FIGS. 12A to 12D are diagrams illustrating test pattern images in the first embodiment;

FIG. 13 is an arrangement diagram of a test pattern in the first embodiment;

FIG. 14 is a flowchart of a reactive liquid amount setting process in the first embodiment;

FIG. 15 is a flowchart of a reactive liquid amount setting process in a second embodiment;

FIG. 16 is a diagram explaining a print condition in the second embodiment;

FIG. 17 is an arrangement diagram of a test pattern in the second embodiment;

FIG. 18 is an arrangement diagram of test patterns in a third embodiment;

FIG. 19 is a flowchart of a reactive liquid amount setting process in the third embodiment; and

FIG. 20 is a diagram explaining a print condition in the third embodiment.

### DESCRIPTION OF THE EMBODIMENTS

Relevance among a test pattern, a type of print medium, a print operation, and a print condition set by the user from among multiple print operations and multiple print conditions (for example, the number of print passes) for each of multiple types of print media are preferably taken into consideration.

It is found that an optimal color ink amount and an optimal reactive liquid amount in a print operation focusing on productivity in which the number of print scanning operations for completing an image is small particularly differ from those in a print operation focusing on image quality in which the number of print scanning operations is large. Moreover, it is found that the optimal color ink amount and the optimal reactive liquid amount in each of the print operations differs depending on wettability of a print medium.

Accordingly, in view of the above-mentioned problems, an object of the present disclosure is to achieve correction of an application amount of the reactive liquid that takes the relevance between the type of print medium and the print condition into consideration.

Examples of embodiments of an inkjet printing apparatus (hereinafter, also referred to as printing apparatus), a control method of the printing apparatus, and a program are explained below in detail with reference to the attached drawings. Note that the following embodiments do not limit the present disclosure, and not all of combinations of features explained in the present disclosure are necessarily essential for the solving means of the present disclosure. Moreover, positions, shapes, and the like of components described in the present disclosure are merely examples, and are not intended to limit the scope of the present disclosure only to these examples.

In the present specification, “printing” does not only mean formation of meaningful information such as characters and figures, and may mean formation of meaningful or meaningless information. Moreover, “printing” widely expresses formation of an image, a design, a pattern or the like on a print medium irrespective of whether or not a formed object is made apparent to be visually perceptible to humans, and also expresses a case of processing a medium.

In the present specification, the “print medium” expresses not only paper used in a general printing apparatus but also widely expresses media capable of receiving inks such as cloth, plastic film, metal plate, glass, ceramics, wood, and leather. Moreover, in the present specification, “inks” should be widely interpreted like the above-mentioned definition of the “printing”. Specifically, “inks” expresses liquids used to form an image, a design, a pattern, or the like or process a print medium by being applied onto the print medium or used to process the inks (for example, solidify or insolubilize color materials in the inks applied to the print medium).

### Configuration of Printing Apparatus

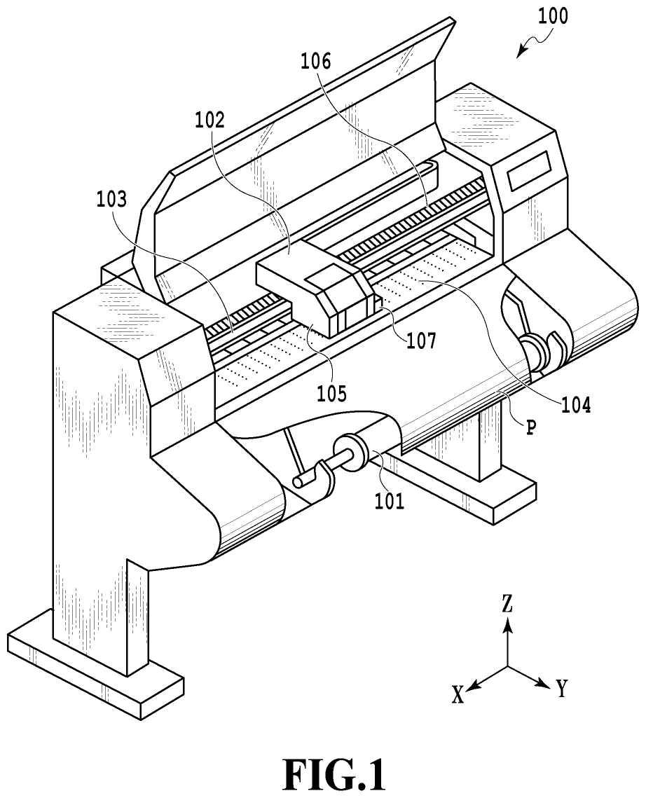

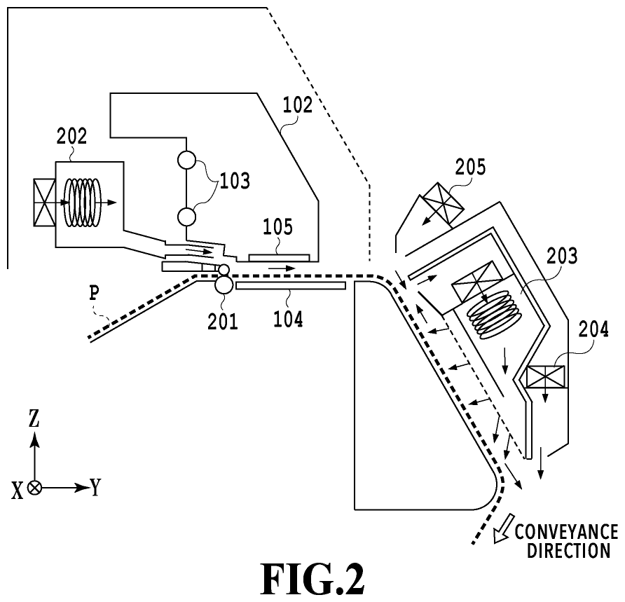

A configuration of a printing apparatus according to the present disclosure and an outline of operations in printing are explained below by using FIGS. 1 and 2. FIG. 1 illustrates an external appearance of the printing apparatus 100 according to the present disclosure. The printing apparatus 100 is a so-called serial scanning type printing apparatus, and prints an image by performing scanning of a print head in an X direction (scanning direction) orthogonal to a Y direction (conveyance direction of a print medium P at a print position to be described later) of the print medium P.

In the printing apparatus 100, a conveyance unit 201 configured to be driven by a not-illustrated conveyance motor via a gear uses a spool 101 holding the print medium P to convey the print medium P in the Y direction. Meanwhile, at a predetermined position in the Y direction (conveyance position), a not-illustrated main scanning motor causes a carriage unit 102 to perform reciprocal scanning (reciprocal movement) along a guide shaft 103 extending in the X direction, in a forward route in a +X direction and a return route in a-X direction. Then, in this scanning process, an ejection operation from ejection ports of a print head 105 attachable to the carriage unit 102 is performed while being synchronized with a timing based on a position signal obtained by an encoder 106 in the main scanning direction, and an image is printed on the print medium P.

Like the print head 105, a detection signal corresponding to the position of the carriage unit 102 is processed while being synchronized with the timing based on the position signal obtained by the encoder 106 in the above-mentioned reciprocal scanning process. A carriage belt can be used for transmission of drive force from the main scanning motor to the carriage unit 102. Note that other drive methods such as a method using a lead screw configured to be rotationally driven by the main scanning motor and extending in the X direction and an engagement portion provided in the carriage unit 102 and configured to engage with a groove in the lead screw may be used instead of the carriage belt.

The fed print medium P is conveyed by a paper feed roller and a pinch roller of the conveyance unit 201 while being held between these rollers, and is guided to the print position (scanning region of the print head) on a platen 104. In a normal hibernation state, a face surface of the print head 105 is capped. Accordingly, a cap is opened prior to printing to set the print head 105 or the carriage unit 102 to a scanning-enabled state. Then, in a case where data for one scanning operation is stored in a buffer, the main scanning motor performs scanning of the carriage unit 102, and printing is performed as described above.

FIG. 2 is a side diagram of the printing apparatus according to the present disclosure. The conveyance unit 201 is formed of the paper feed roller and the pinch roller, and conveys the print medium P. The print medium P conveyed by the spool 101 (see FIG. 1) is subjected to printing by the print head 105, and is then rolled up by a not-illustrated roll-up spool to form a roll-shaped rolled-up medium. The inks are ejected from the print head 105 attached to the carriage unit 102, and are applied onto the print medium P while the scanning of the carriage unit 102 is performed in the X direction. In this case, the conveyance unit 201 intermittently conveys the print medium P in the +Y direction to form an image on the print medium P. The platen 104 faces the print head 105 across the scanning region of the print head 105 and the carriage unit 102, and sucks the print medium P from the back surface side of the print medium P to prevent lifting of the print medium P.

Next, a configuration for drying and fixing the inks are explained. A platen air blowing unit 202 is a unit that blows heated air to a surface of the print medium P on the platen 104. This can promote evaporation of water content contained in the inks ejected onto the surface of the print medium P on the platen 104, and promote fixing of the inks. A fixing unit 203 is a unit that dries and fixes the inks applied to the print medium P. The fixing unit 203 has a substantially box shape, and a bottom surface of the fixing unit 203 faces a conveyance surface of the print medium P. Blowing heated air from this bottom surface toward the print medium P heats the print medium P and the inks applied to the print medium P, causes water and solvent contained in the inks to evaporate, and causes emulsion to turn into a film.

A down flow unit 204 causes the heated air discharged from the fixing unit 203 to blow toward a floor direction. An air curtain unit 205 is a unit that creates a curtain of air by using a strong jet flow, and may be provided in a middle of a route from the platen 104 to the fixing unit 203 as illustrated. Providing the air curtain unit 205 can prevent ink mist caused to drift by the platen air blowing unit 202 from entering an inside of the fixing unit 203.

### Configuration of Print Head

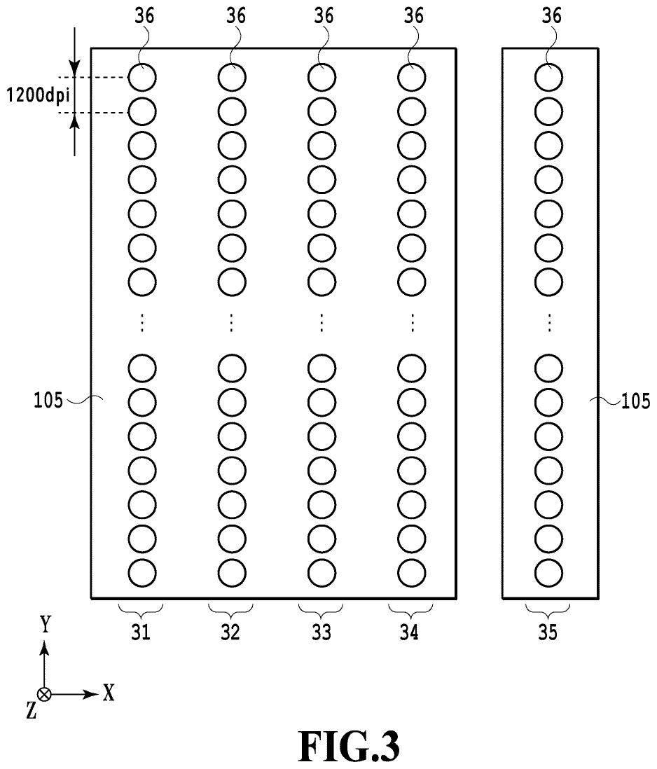

A configuration of a print head according to the present disclosure is explained below by using FIG. 3. FIG. 3 is a diagram schematically illustrating an array of ejection ports in the print head 105 according to the present disclosure.

The print head 105 includes an ejection port array 31 configured to eject a black ink as an ink containing a color material, an ejection port array 32 configured to eject a cyan ink, an ejection port array 33 configured to eject a magenta ink, and an ejection port array 34 configured to eject a yellow ink. Since these inks contain color materials, respectively, these inks are also referred to as color inks in the following explanation for the sake of simplification.

Moreover, the print head 105 includes an ejection port array 35 configured to eject a reactive liquid that contains no color material, and the ejection port array 35 has a configuration in which a head is separate from that of the color inks in the present example. This reactive liquid contains no color materials, and contains a reactive component that reacts with the color materials contained in the color inks. Bringing the color inks and the reactive liquid into contact with one another on the print medium causes coagulation and the like of the color materials contained in the color inks, and this can suppress bleeding. In the print head 105, these ejection port arrays are arranged in order of the ejection port array 31, the ejection port array 32, the ejection port array 33, the ejection port array 34, and the ejection port array 35 from the +side toward the −side of the X direction. Each of these ejection port arrays is formed by aligning 1,280 ejection ports 36 configured to eject the ink, in the Y direction (alignment direction) at a density of 1,200 dpi.

Note that an amount of ink droplet ejected from one ejection port 36 in one ejection operation according to the present disclosure is about 5 pl. Each of the ejection port arrays 31 to 35 illustrated in FIG. 3 is connected to a not-illustrated ink tank configured to store the corresponding ink, and the ink is supplied. The print head 105 and the ink tanks may be configured to be separable from one another, or may be configured to be integral with one another. A detailed composition of each of the black ink, the cyan ink, the magenta ink, the yellow ink, and the reactive liquid is described later.

### Control Configuration of Printing Apparatus

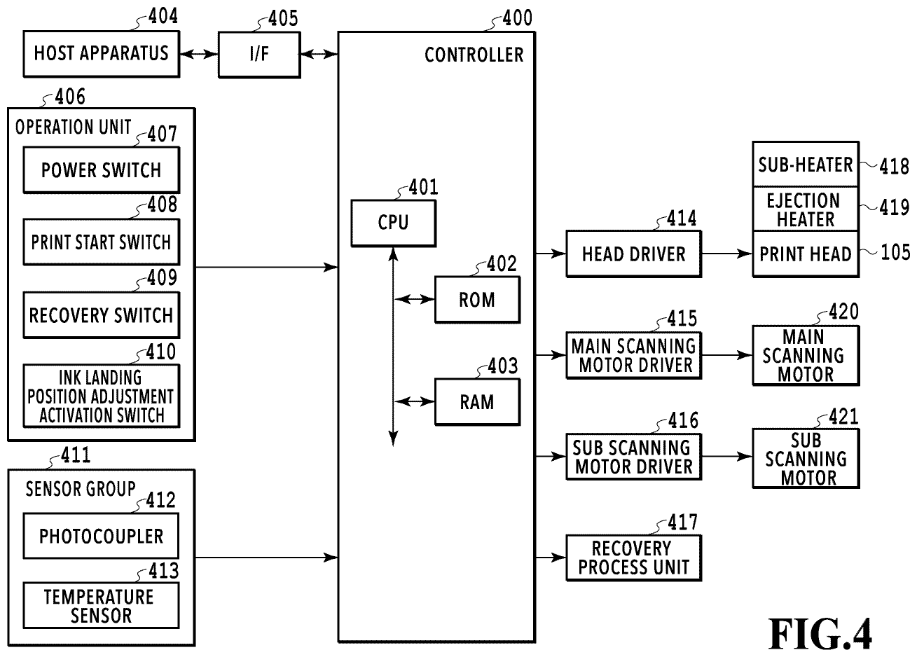

FIG. 4 is a block diagram for explaining a configuration relating to control of the printing apparatus 100.

A controller 400 that is a main control unit includes, for example, a CPU 401 of a microcomputer form, a ROM 402 configured to store programs, necessary tables, and other pieces of fixed data, and a RAM 403 in which a work region, a region for expanding image data, and the like are provided. The CPU 401 executes a process for ink landing position adjustment to be described later. In the process for ink landing position adjustment, an adjustment value for the ink landing position adjustment is set, and the set adjustment value is then used in an actual print process to be put to use for adjustment of ink landing positions. A host apparatus 404 is a supply source of the image data, and may have a form of a computer that performs creation, processing, and the like of data such as an image relating to printing or a form of a reader unit for reading an image. The host apparatus 404 exchanges the image data, other commands, status signals, and the like with the controller 400 via an interface (I/F) 405.

An operation unit 406 is a switch group that receives instruction inputs made by an operator, and includes a power switch 407, a print start switch 408 for instructing print start, and a recovery switch 409 for instructing activation of a suction recovery operation for the print head 105. Moreover, the operation unit 406 includes an ink landing position adjustment activation switch 410 for performing the ink landing position adjustment. In the present disclosure, the print start, the recovery operation, and the ink landing position adjustment are assumed to be executed by using switches provided in a main body of the printing apparatus 100. However, these operations can be executed based on instructions from the host apparatus 404 (that is from an information processing apparatus) including a display unit.

A sensor group 411 is a sensor group for detecting a state of the printing apparatus 100, and includes a reflective optical sensor 107 (see FIG. 1), a photocoupler 412 for detecting a home position, and a temperature sensor 413 provided in an appropriate portion to detect an environmental temperature.

A head driver 414 is a driver configured to drive ejection heaters 419 of the print head 105 according to print data and the like. The head driver 414 includes a shift register configured to align the print data such that the print data corresponds to positions of the ejection heaters 419, a latch circuit configured to perform latching at an appropriate timing, and a logical circuit element that causes the ejection heaters 419 to operate in synchronization with a drive timing signal. A sub-heater 418 is provided in the print head 105. The sub-heater 418 is a unit that performs temperature adjustment for stabilizing ejection characteristics of the inks, and may have a form in which the sub-heater 418 is formed on a print head substrate together with the ejection heaters 419 or a form in which the sub-heater 418 is attached to the print head 105. A main scanning motor driver 415 is a driver for driving a main scanning motor 420. A sub scanning motor 421 is a motor used to convey the print medium P (move the print medium P in a sub scanning direction) via a conveyance roller, and a sub scanning motor driver 416 is a driver for driving the sub scanning motor 421. A recovery process unit 417 performs a recovery process for maintaining a preferable ejection state of the inks in the print head 105.

### Multi-Pass Print Control

In the present disclosure, an image is printed by performing multi-pass print control in which printing is performed by using the color inks and the reactive liquid while performing multiple scanning operations for a unit region on the print medium. Note that, in the present example, printing is completed by performing eight scanning operations for the unit region.

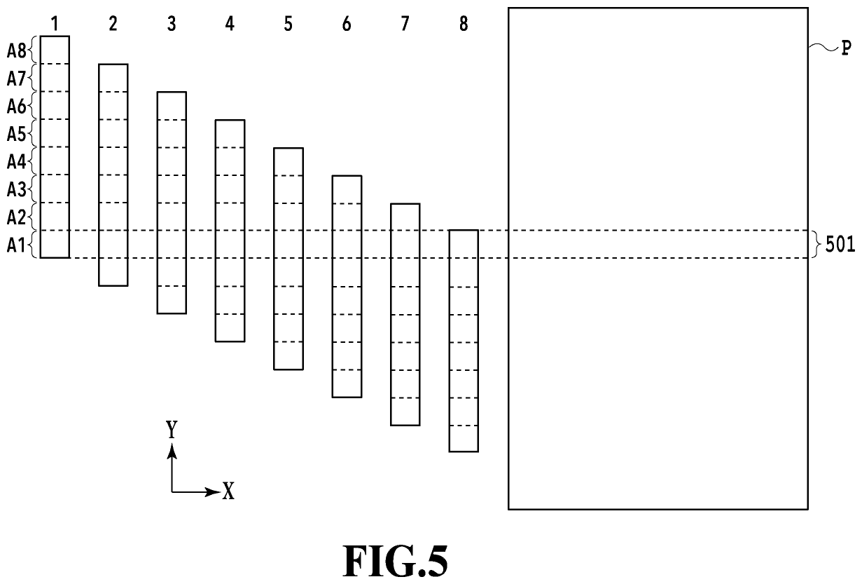

FIG. 5 is a diagram for explaining control based on a multi-pass printing method performed in the present disclosure. In the present disclosure, each of the ejection port arrays 31 to 35 is divided into eight ejection port groups A1 to A8 in the Y direction, and the color inks and the reactive liquid are ejected from the eight ejection port groups A1 to A8, respectively, in the eight scanning operations performed for the unit region. Note that, in an actual operation, the print medium P is conveyed downstream in the Y direction between scanning operations of the print head 105. However, in FIG. 5, illustration is such that the print head 105 is moved upstream in the Y direction between scanning operations for convenience of explanation.

First, in a first scanning operation, the scanning of the print head 105 is performed in a positional relationship in which a unit region 501 on the print medium P and the ejection port groups A1 in the respective ejection port arrays face one another, and the color inks and the reactive liquid are ejected from the ejection port groups A1 to the unit region 501 according to the print data corresponding to the first scanning operation. After completion of the first scanning operation, the print medium P is conveyed in the Y direction by a distance corresponding to one ejection port group. Next, a second scanning operation is performed, and the color inks and the reactive liquid are ejected from the ejection port groups A2 to the unit region 501 according to the print data corresponding to the second scanning operation. Then, the conveyance of the print medium P and the ejection from the print head are alternately performed, and ejection from the ejection port groups A3 to A8 is executed in third to eighth scanning operations performed for the unit region 501. The multi-pass printing on the unit region 501 is thereby completed.

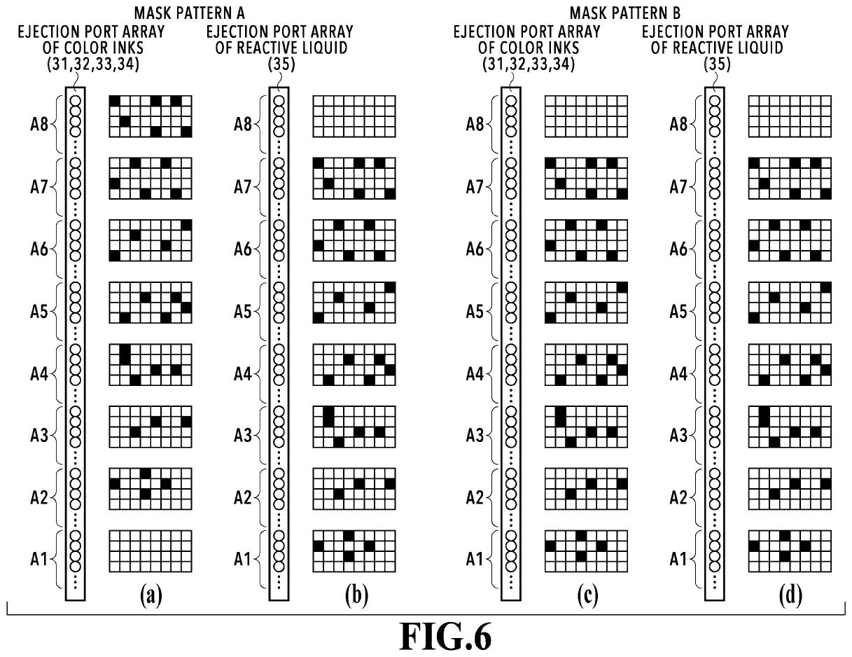

FIG. 6 is a diagram illustrating mask patterns used in the present disclosure. In the mask patterns illustrated FIG. 6, pixels painted in black indicate pixels for which ejection of the inks is permitted in the case where ejection of the inks is determined in quantified data. Meanwhile, pixels illustrated in white indicate pixels for which ejection of the inks is not permitted even in the case where ejection of the inks is determined in the quantified data. Moreover, FIG. 6 illustrates the mask patterns each having a size of 4 pixels×8 pixels, and a distribution process is performed on the entire quantified data corresponding to each unit region by repeatedly applying these mask patterns in the X direction and the Y direction.

The symbol (a) in FIG. 6 illustrates a mask pattern group applied to the quantified data corresponding to the ejection port array 31 of the black ink, the ejection port array 32 of the cyan ink, the ejection port array 33 of the magenta ink, and the ejection port array 34 of the yellow ink that are the ejection port arrays of the color inks. As illustrated in the symbol (a) in FIG. 6, for the ejection port groups A1 to A8 of the color ink ejection port arrays corresponding to the first to eighth scanning operations, the print permitted pixels are arranged only in the mask patterns corresponding to the ejection port groups A2 to A8 corresponding to the second to eighth scanning operations. Moreover, in the mask pattern corresponding to the ejection port group A1 corresponding to the first scanning operation, no print permitted pixels are arranged. Accordingly, in the present disclosure, the color inks are ejected in the second to eighth scanning operations among the eight scanning operations.

Meanwhile, as illustrated in the symbol (b) in FIG. 6, for the ejection port array 35 of the reactive liquid, the print permitted pixels are arranged in the mask patterns corresponding to the ejection port groups A1 to A7 corresponding to the first to seventh scanning operations among the ejection port groups A1 to A8 corresponding to the first to eighth scanning operations. No print permitted pixels are arranged in the mask pattern corresponding to the ejection port group A8 corresponding to the eighth scanning operation. Accordingly, in the present disclosure, the reactive liquid is ejected in the first to seventh scanning operations among the eight scanning operations.

As explained above, the reactive liquid is ejected onto the print medium prior to ejection of the color inks. Accordingly, in the case where the color inks are ejected to the print medium, coagulation of pigments caused by the reactive liquid immediately starts. As a result, bleeding of the color inks can be preferably reduced. Moreover, the color inks and the reactive liquid can be printed in the same print scanning operation by switching the mask patterns depending on the print medium as illustrated in the symbols (c) and (d) in FIG. 6. In the present example, the symbols (a) and (b) in FIG. 6 are referred to as mask pattern A (also referred to as first mask pattern), and the symbols (c) and (d) in FIG. 6 are referred to as mask pattern B (also referred to as second mask pattern). Moreover, the print medium on which the color inks and the reactive liquid are printed is conveyed and made to pass the fixing unit 203 to heat and dry the inks. In this case, the inks are dried and fixed also on a non-absorbent print medium or a low-absorbency print medium, and the printing is completed.

### Compositions of Inks

A composition of each ink is explained below in detail.

The color inks and the reactive liquid used in the present disclosure all contain a water-soluble organic solvent. The water-soluble organic solvent is preferably a solvent with a boiling point of 150° C. or more and 300° C. or less for reasons of wettability and a moisture retaining property of the face surface of the print head 105. The water-soluble organic solvent is particularly preferably a ketone compound such as acetone or cyclohexanone, an ethylene glycol derivative such as tetraethylene glycol dimethyl ether, a heterocyclic compound with a lactam structure typified by N-methyl-pyrrolidone and 2-pyrrolidone, or the like. The content of the water-soluble organic solvent is preferably 3 wt % or more and 30 wt % or less from a viewpoint of ejection performance. Examples of the water-soluble organic solvent specifically include: alkyl alcohols with a carbon number of 1 to 4 such as, for example, methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones and keto alcohols such as acetone or diacetone alcohol; ethers such as tetrahydrofuran and dioxane; polyalkylene glycols such as polyethylene glycol and polypropylene glycol; ethylene glycol; alkylene glycols in which an alkylene group contains two to six carbon atoms such as propylene glycol, butylene glycol, triethylene glycol, 1,2,6-hexanetriol, thiodiglycol, hexylene glycol, and diethylene glycol; lower alkyl ether acetates such as polyethylene glycol monomethyl ether acetate; glycerin; lower alkyl ethers of polyhydric alcohol such as ethylene glycol monomethyl (or ethyl) ether, diethylene glycol methyl (or ethyl) ether, and triethylene glycol monomethyl (or ethyl) ether; polyhydric alcohols such as trimethylolpropane and trimethylolethane; N-methyl-2-pyrrolidone; 2-pyrrolidone; 1,3-dimethyl-2-imidazolidinone; and the like. The above-mentioned water-soluble organic solvents can be used alone or as a mixture. Moreover, deionized water is desirably used as water. Note that the content of the water-soluble organic solvent in the reactive liquid (RCT) is not limited to a particular content, and a surfactant, a debubbling agent, a preservative, a fungicide, and the like may be added as appropriate to the color inks (C, M, Y, K) in addition to the above-mentioned components to provide desired physical property values as necessary.

Moreover, the color inks and the reactive liquid used in the present disclosure all contain a surfactant. The surfactant is used as a penetrating agent for the purpose of improving penetrating properties of the inks for an inkjet-specific print medium. The larger the additive amount of the surfactant is, the stronger the property of reducing the surface tensions of the inks is, and the more the wettability and the penetrating property of the inks for the print medium are improved. In the present disclosure, a small amount of an acetylene glycol EO adduct and the like are added as the surfactant to adjust the surface tension of each ink to 30 dyn/cm or less and to adjust differences among the surface tensions of the inks to 2 dyn/cm or less. To be more specific, the surface tensions of the respective inks are adjusted to be within a range of about 28 dyn/cm to 30 dyn/cm. Fully-automatic surface tensiometer CBVP-Z (manufactured by Kyowa Interface Science Co., Ltd.) is used for the measurement of the surface tensions. Note that the measurement device is not limited to the device introduced in the present specification, and may be any measurement device as long as the measurement device can measure the surface tensions of the inks.

Moreover, pHs of the respective inks according to the present disclosure are all stable on the alkaline side, and the values thereof are in a range of 8.5 to 9.5. The pH of each ink is preferably 7.0 or more and 10.0 or less from a viewpoint of preventing elution and degradation of members in contact with the ink in the printing apparatus and the print head, a decrease in solubility of a resin dispersed in the ink, and the like. For the measurement of the pH, pH METER F-52 manufactured by Horiba, Ltd. is used. Note that the measurement device is not limited to the above-introduced device, and may be any measurement device as long as the measurement device can measure the pH of each ink.

The cyan ink and the magenta ink among the black ink, the cyan ink, the magenta ink, and the yellow ink used in the present disclosure are explained in detail for the sake of simplification.

Preparation of a dispersion liquid of the magenta ink is explained below.

First, an AB block polymer with an acid value of 300 and a number-average molecular weight of 2,500 is produced by an ordinary method with benzyl acrylate and methacrylic acid used as raw materials. Then, the AB block polymer is neutralized by a potassium hydroxide aqueous solution and diluted by deionized water to prepare a homogenous 50 mass % polymer aqueous solution. Next, 100 g of the prepared polymer aqueous solution, 100 g of C.I. pigment red 122, and 300 g of deionized water are mixed and mechanically agitated for 0.5 hours. Next, this mixture is processed with a microfluidizer by being passed through an interaction chamber five times under a liquid pressure of about 70 MPa.

Furthermore, the above-mentioned obtained dispersion liquid is subjected to a centrifugal process (12,000 rpm, 20 minutes) to remove not-dispersed objects including coarse particles, and a magenta dispersed liquid is obtained. The obtained magenta dispersion liquid has a pigment concentration of 10 mass % and a dispersant concentration of 5 mass %.

Next, ink preparation relating to the magenta ink is explained.

In the ink preparation, the magenta dispersion liquid described above is used, and the following components are added to the magenta dispersion liquid to achieve a predetermined concentration. These components are sufficiently mixed and agitated, and then subjected to pressure filtering using a micro filter (manufactured by Fujifilm Corporation) with a pore size of 2.5 μm to prepare a color ink with a pigment concentration of 4 mass % and a dispersant concentration of 2 mass %.
Above-mentioned magenta dispersion liquid 40 parts
2-Pyrrolidone 5 parts
2-methyl-1,3-propanediol 15 parts
Acetylene glycol EO adduct 0.5 parts
Deionized water (manufactured by Kawaken Fine Chemicals Co., Ltd.) balance

Preparation of a dispersion liquid of the cyan ink is explained below.

First, an AB block polymer with an acid value of 250 and a number-average molecular weight of 3,000 is produced by an ordinary method with benzyl acrylate and methacrylic acid used as raw materials. Then, the AB block polymer is neutralized by a potassium hydroxide aqueous solution and diluted by deionized water to prepare a homogenous 50 mass % polymer aqueous solution. Next, 180 g of the prepared polymer aqueous solution, 100 g of C.I. pigment blue 15:3, and 220 g of deionized water are mixed and mechanically agitated for 0.5 hours. Next, this mixture is processed with a microfluidizer by being passed through an interaction chamber five times under a liquid pressure of about 70 MPa.

Furthermore, the above-mentioned obtained dispersion liquid is subjected to a centrifugal process (12,000 rpm, 20 minutes) to remove not-dispersed objects including coarse particles, and a cyan dispersed liquid is obtained. The obtained cyan dispersion liquid has a pigment concentration of 10 mass % and a dispersant concentration of 10 mass %.

Next, ink preparation relating to the cyan ink is explained.

In the ink preparation, the cyan dispersion liquid described above is used, and the following components are added to the cyan dispersion liquid to achieve a predetermined concentration. These components are sufficiently mixed and agitated, and then subjected to pressure filtering using a micro filter (manufactured by Fujifilm Corporation) with a pore size of 2.5 μm to prepare a color ink with a pigment concentration of 4 mass % and a dispersant concentration of 2 mass %.
Above-mentioned cyan dispersion liquid 20 parts
2-Pyrrolidone 5 parts
2-methyl-1,3-propanediol 15 parts
Acetylene glycol EO adduct 0.5 parts
Deionized water (manufactured by Kawaken Fine Chemicals Co., Ltd.) balance

The reactive liquid used in the present disclosure contains a reactive component that reacts with the pigments contained in the inks and causes the pigments to coagulate or turn into a gel. This reactive component is specifically a component as follows. In the case where the reactive component is mixed with an ink containing a pigment stably dispersed or dissolved in an aqueous medium by an action of an ionic group on the print medium or the like, the reactive component can disrupt dispersion stability of the ink. In detail, glutaric acid is used in the present disclosure as described below.

Note that glutaric acid does not have to be used as the reactive component of the reactive liquid. In the present disclosure, various organic acids can be used as the reactive component of the reactive liquid as long as the organic acids are water-soluble. Specific examples of the organic acids include oxalic acid, polyacrylic acid, formic acid, acetic acid, propionic acid, glycolic acid, malonic acid, malic acid, maleic acid, ascorbic acid, levulinic acid, succinic acid, glutaric acid, glutamic acid, fumaric acid, citric acid, tartaric acid, and lactic acid. Moreover, the specific examples include pyrrolidone carboxylic acid, pyronecarboxylic acid, pyrrolecarboxylic acid, furancarboxylic acid, pyridinecarboxylic acid, coumalic acid, thiophenecarboxylic acid, nicotinic acid, oxysuccinic acid, and dioxysuccinic acid. The content of the organic acid is preferably 3.0 mass % or more and 90.0 mass % or less based on a total mass of compositions contained in the reactive liquid, and is more preferably 5.0 mass % or more and 70.0 mass % or less.

Preparation of the reactive liquid is explained below.

In the present disclosure, as described above, glutaric acid (manufactured by Wako Pure Chemical Corporation) is used as the organic acid, and the reactive liquid is prepared by mixing the following components.
Glutaric acid 3 parts
2-Pyrrolidone 5 parts
2-Methyl-1,3-propanediol 15 parts
Acetylene glycol EO adduct 0.5 parts
Deionized water (manufactured by Kawaken Fine Chemicals Co., Ltd.) Balance

As a printing method using the color inks and the reactive liquid, necessary amounts of the color inks and the reactive liquid are printed in an identical region, and the reactive liquid and the color inks are thereby brought into contact with one another at a certain frequency. An effect of suppressing bleeding that significantly occurs particularly on a non-absorbent print medium can be thereby obtained. Moreover, the print medium P on which the color inks and the reactive liquid are printed is conveyed to pass the fixing unit 203 that heats and dries the print medium P, and this heats and dries the color inks. The color inks are dried and fixed also on the non-absorbent print medium or the low-absorbency print medium, and the printing is completed.

### Print Medium

The printing apparatus 100 according to the present disclosure can perform printing on multiple types of print media. The print media that can be subjected to printing in the printing apparatus 100 include the non-absorbent print medium into which no water content contained in the color inks permeate, the low-absorbency print medium that has low absorbency of water content contained in the color inks, and an inkjet print medium with high absorbency of water content. The absorbency of the print medium can be roughly categorized into three groups as described above.

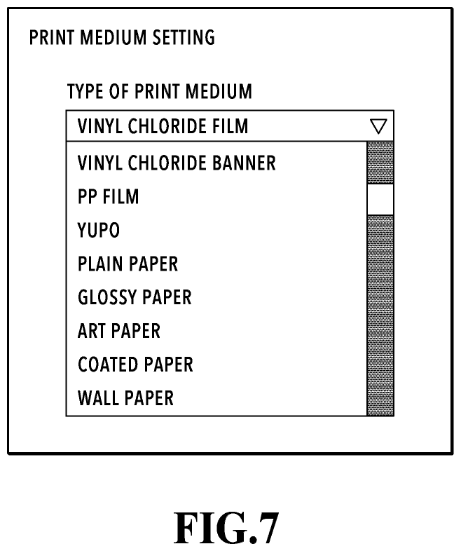

FIG. 7 is a diagram schematically illustrating a graphical user interface window (hereinafter, referred to as GUI window) displayed on a display of the host apparatus 404 in the case where a user inputs information on the type of print medium. In FIG. 7, nine types of print media of “vinyl chloride film”, “vinyl chloride banner”, “PP film”, “Yupo”, “plain paper”, “glossy paper”, “art paper”, “coated paper”, and “wall paper” are displayed. “Vinyl chloride film”, “vinyl chloride banner”, “PP film”, and “Yupo” are print media into which water content contained in the color inks is less likely to permeate. Specifically, these print media include a print medium in which a layer of plastic is formed on an outermost surface of a base material, a print medium in which no ink receiving layer is formed on a base material, glass, Yupo, a sheet or a film of plastic or the like, a banner, and the like. Examples of the coated plastic described above include polyvinyl chloride, polyethylene terephthalate, polycarbonate, polystyrene, polyurethane, polyethylene, polypropylene, and the like. Since these print media with low absorbency have excellent water resistance, lightfastness, and scratch resistance, these print media are generally used in the case where a print product for outdoor exhibition is to be printed. The “glossy paper”, the “art paper”, and the “coated paper” are inkjet print media with high absorbency into which water content contained in the color inks permeates. These print media are inferior to print media with low-absorbency in terms of water resistance, lightfastness, and scratch resistance. However, since the print media with high absorbency can absorb the applied color inks into ink receiving layers, these print media have excellent color reproduction properties, and enables printing with high image quality. Accordingly, these print media are generally used in the case where a print product for indoor exhibition is to be printed. Since these print media have high absorbency and the color inks permeate into the print media before coming into contact with one another, the reactive liquid is unnecessary. Meanwhile, surface layers of “plain paper” and “wall paper” are formed of a pulp material or a coating layer, and thus have low absorbing rate of water content, and “plain paper” and “wall paper” are classified into low-absorbency print media. In the low-absorbency print media, the color inks come into contact with one another before being absorbed into the print media, and bleeding of the color inks occurs. Accordingly, the reactive liquid is used to prevent the bleeding of the color inks also in the low-absorbency print media. An index that quantifies the “absorbency” of each print medium to classify the print medium into the low-absorbency print medium or the non-absorbent print medium is a transfer amount Vt of liquid per unit time. As a method of measuring the transfer amount Vt of liquid, there is a method called “Bristow method” in which a water absorption amount in a short period immediately after contact with water is measured.

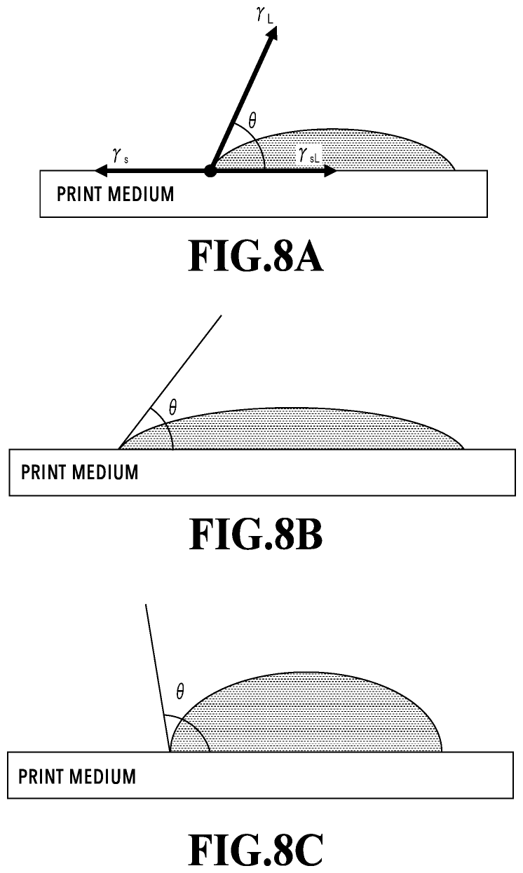

In the Bristow method, a certain amount V of liquid is put into a container with a small opening, and the opening is brought into contact with a paper surface while an area wL of a portion where the liquid is transferred is measured. The transfer amount Vt of liquid per unit time can be thereby calculated according to a formula Vt=V/wL. However, measurement of the transfer amount of the ink to the print medium requires use of a dedicated device for measuring Bristow, and incorporating this dedicated device in a general printing apparatus is not practical. Moreover, in the non-absorbent print medium into which water content contained in the color inks is less likely to permeate and the low-absorbency print medium that has low absorbency of water content contained in the color inks, the surface tension of the color inks applied to each print medium changes depending on a surface energy of a surface layer of the print medium. Accordingly, the print media are categorized into a wettable print medium and a less-wettable print medium. An index for quantifying “wettability” of each print medium is “contact angle” (θ). As illustrated in FIG. 8A, a tangent angle θ between a tangent of a droplet and a solid surface is referred to as “contact angle”, and can be calculated by using Young's equation γs=γL·cosθ+γsL.

FIG. 8B is a diagram illustrating a print medium with high wettability. In the print medium with high wettability, the tangent angle θ is small, and in the case where liquid such as the color inks is applied, the liquid wets the print medium and spreads. Meanwhile, FIG. 8C is a diagram illustrating a print medium with low wettability. In the print medium with low wettability, the tangent angle θ is large, and in the case where liquid such as the color inks is applied, the liquid does not wet the print medium and spread. However, measurement of the tangent angle θ between the print medium and each color ink requires use of a dedicated contact angle meter, and incorporating this dedicated contact angle meter in a general printing apparatus is not practical.

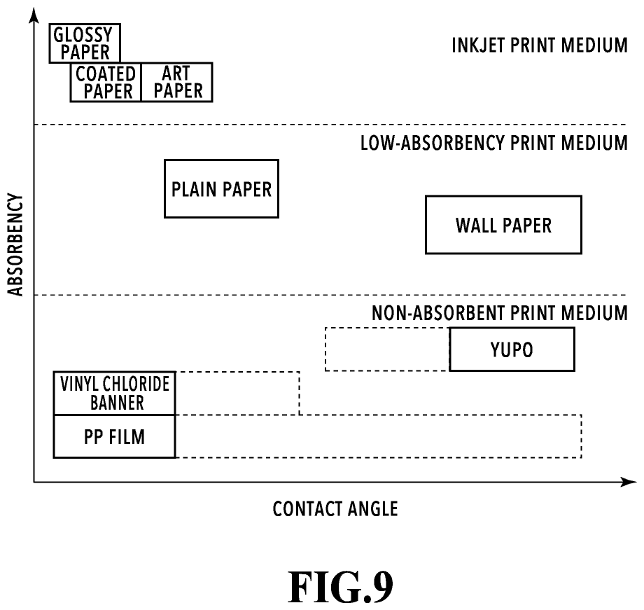

In the case where print media registered in advance are used, it is possible to collect “absorbency” and “wettability” in advance and prepare and provide printing means in advance depending on the collected “absorbency” and “wettability”. FIG. 9 is a diagram explaining distribution of “absorbency” and “wettability” for each type of print medium. As described above, classification of “absorbency” is based on a base material, coating, and the like, and “glossy paper”, “art paper”, and “coated paper” are classified into the inkjet print medium. “Plain paper” and “wall paper” are classified into the low-absorbency print medium. “Vinyl chloride film”, “vinyl chloride banner”, “PP film”, and “Yupo” are classified into the non-absorbent print medium. Meanwhile, regarding “wettability”, the wettability may greatly differ from print medium to print medium depending on processing conditions, material treatment, and the like.

### FIRST EMBODIMENT

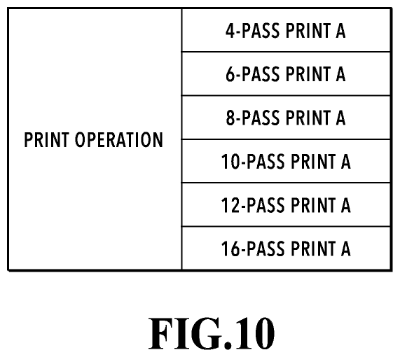

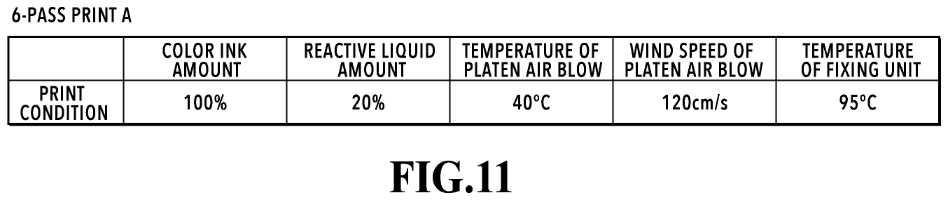

In the first embodiment, first, one of multiple types of print media (for example, see FIG. 7) registered in advance is selected for a print medium not registered in advance. Then, one of multiple print operations (for example, see FIG. 10) corresponding to the selected type is selected. Next, a print condition for the selected print operation is set (for example, see FIG. 11). Then, multiple test pattern images based on the selected type of print medium, the selected print operation, and the set print condition are printed. Next, one of the printed multiple test pattern images is selected to determine or set an optimal reactive liquid amount.

FIG. 10 illustrates a list of combinations of the number of print passes and the print pattern as print operations selectable in the case where “vinyl chloride film” is selected through the GUI window for print medium setting illustrated in FIG. 7. Each print operation is defined by at least one of the number of print scanning operations (number of print passes) used in multi-pass printing, the used mask pattern, or the used ink colors. In the present example, selectable types of the number of passes are six types from 4 passes to 16 passes as illustrated in FIG. 10, and the mask pattern A is used as the mask pattern. Note that, as illustrated in the symbols (a) and (b) in FIG. 6, the mask pattern A is the pattern in which the reactive liquid is printed prior to the color inks.

FIG. 11 illustrates initial setting values in the print condition for “6-pass print A” that is one of the six types of print operations illustrated in FIG. 10. These initial setting values are setting values for a print medium with low wettability. The color ink amount can be set in a range of 70% or more to 120% or less, the reactive liquid amount can be set in a range of 0% or more to 50% or less, the temperature of platen air blow can be set in a range of 35° C. or more to 45° C. or less, the wind speed of platen air blow can be set in a range of 100 cm/sec or more to 500 cm/sec or less, the temperature of the fixing unit can be set in a range of 75° C. or more to 120° C. or less. In this case, “100%” for the color ink amount and the reactive liquid amount is such an amount that two ink droplets each of about 5 pl is applied to a 1,200-dpi matrix. Note that, although the case where the print condition is defined by the color ink amount, the reactive liquid amount, the temperature of platen air blow, the wind speed of platen air blow, and the temperature of fixing unit is described in the present example, the present embodiment is not limited to this. The printing condition only needs to include one or more of these items.

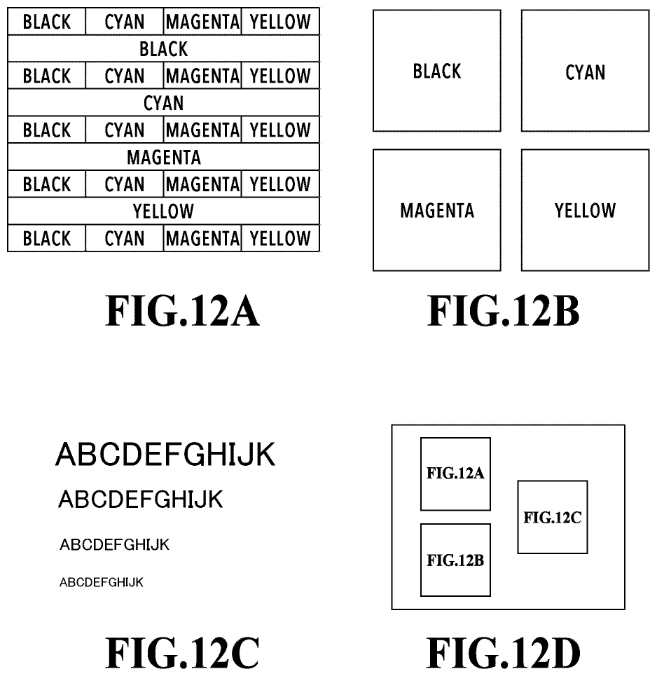

FIGS. 12A to 12D illustrate test pattern images in the present embodiment. Specifically, FIG. 12A is an image in which solid color images of black color, cyan color, magenta color, and yellow color that are different ink colors are adjacent to one another and that is used to check bleeding occurring at boarders of the adjacent solid color images. FIG. 12B is an image of uniform colors of black color, cyan color, magenta color, and yellow color that is used to check graininess (uniformness). FIG. 12C is character images of black color that differ from one another in font size and that are used to check character quality. FIG. 12D is an image in which the images, respectively, of FIGS. 12A to 12C described above are arranged and that is used to check bleeding, graininess (uniformness), and character quality together.

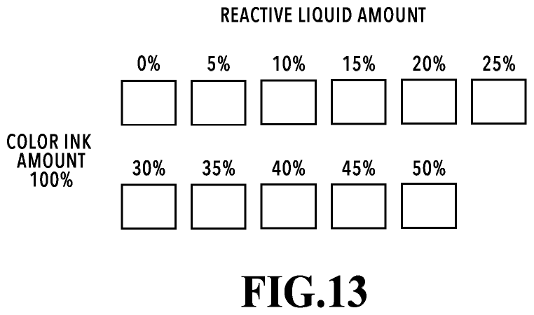

FIG. 13 illustrates an arrangement diagram of a test pattern in the present embodiment, and 11 images that are each the image illustrated in FIG. 12D and that differ from one another in the reactive liquid amount are arranged in the present example. Specifically, there are printed duplicative images obtained by applying the reactive liquid at different application amounts to images with the color ink amount of 100% that is the initial setting amount (see FIG. 11), the different application amounts being reactive liquid amounts from 0% to 50% at intervals of 5%.

### Printing of Test Pattern, Setting of Reactive Liquid Amount

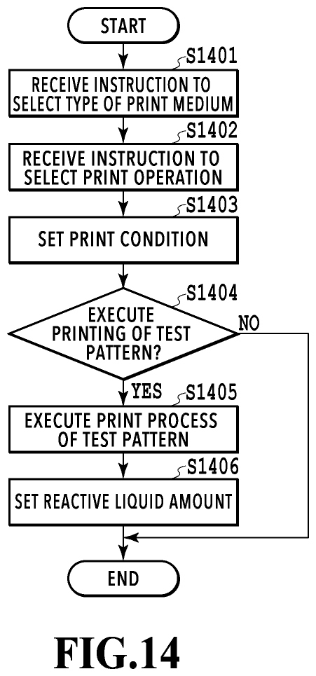

FIG. 14 is a flowchart of a reactive liquid amount setting process involving printing of the test pattern in the present embodiment.

In step S1401, the CPU 401 receives an instruction for selecting the type of print medium corresponding to the print medium that is not registered in advance, from the user. The instruction received in the present step is inputted by the user through the GUI window as illustrated in FIG. 7. Note that explanation is given hereinafter by using a case where the CPU 401 receives an instruction to select “vinyl chloride film” in the present step for the sake of convenience. Moreover, “step S” is abbreviated as “S”.

In S1402, the CPU 401 receives an instruction to select the print operation. The instruction received in the present step is an instruction for designating one print operation that is selected by the user from among multiple print operations selectable for the type of print medium selected in S1401 in view of productivity and image quality and that is to be used in actual image output. Specifically, for example, in the case where the CPU 401 receives the instruction to select “vinyl chloride film” in S1401, the instruction received in the present step is an instruction of designating one of the six print operations illustrated in FIG. 10. Note that the instruction from the user is not essential for the selection of print operation, and a predetermined print operation may be selected. Moreover, explanation is given hereinafter by using a case where the CPU 401 receives an instruction to select “6-pass print A” focusing on productivity in the present step for the sake of convenience.

In S1403, the CPU 401 sets the print condition for the type of print medium indicated by the instruction received in S1401 and the print operation indicated by the instruction received in S1402. Specifically, for example, the CPU 401 sets values based on the initial setting values (see FIG. 11) of the respective parameters corresponding to the combination of “vinyl chloride film” and “6-pass print A”. In detail, the initial setting values may be set as they are as the print condition, or values adjusted from the initial setting values to be values suitable for an output image as necessary may be set as the print condition. Note that, hereinafter, it is assumed that the initial setting values illustrated in FIG. 11 are set as they are as the print condition in the present step for the sake of convenience. Moreover, the setting of the present step may be automatically performed or selectively performed based on an instruction from the user.

In S1404, the CPU 401 determines whether to execute printing of the predetermined test pattern (for example, see FIG. 13) on the print medium of the type selected in S1401 based on the print operation selected in S1402 and the print condition set in S1403. For example, assume that there is a button configured to be pressed by the user in the case of instructing start of printing of the test pattern. In the case where the CPU 401 receives pressing of this button, the CPU 401 may determine YES in the present step. In the case where the determination result of the present step is YES, the process proceeds to S1405. Meanwhile, in the case where the determination result of the present step is NO, the series of processes is terminated.

In S1405, the CPU 401 executes a print process of printing the predetermined test pattern (for example, see FIG. 13) on the print medium of the type selected in S1401 based on the print operation selected in S1402 and the print condition set in S1403. Note that, regarding the reactive liquid amount printed in the case where the print process is executed in the present step, values in a predetermined range that differ from one another at intervals of a predetermined value are used instead of 20% (see FIG. 11) that is the initial setting value. Such values include, for example, values from 0% to 50% that differ from one another at intervals of 5% (see FIG. 13).

In S1406, the CPU 401 sets the reactive liquid amount based on an instruction received from the user. The instruction received in the present step is an instruction in which the user has selectively determined the reactive liquid amount at which an image defect is most suppressed by visually recognizing each of the images of FIGS. 12A to 12C (see FIG. 13) for each of the reactive liquid amounts. Specifically, for example, in the case where 25% is superior to 20% that is the initial setting value from a viewpoint of bleeding suppression, the user determines 25% as the reactive liquid amount. This causes 25% to be set as the reactive liquid amount in the print condition for the combination of “vinyl chloride film” and “6-pass print A”.

As explained above, in the present embodiment, first, the type of print medium is selected for the print medium that is not registered in advance. Next, one print operation is selected from among the multiple print operations corresponding to the selected type. Then, the print condition for the selected print operation is set. Next, multiple test pattern images are printed based on the print operation and the print condition set as described above. Then, the user selects one of the printed multiple test pattern images.

In such a configuration, the reactive liquid amount that is for the predetermined color ink amount and at which an image defect is suppressed can be appropriately set.

### SECOND EMBODIMENT

In a second embodiment, first, a test pattern is selected for the print medium that is not registered in advance. Then, the type of print medium on which the selected test pattern is to be printed is selected, the print operation is selected, and the print condition is set. Next, multiple test pattern images are printed based on the selected type of print medium, the selected print operation, and the set print condition. Then, one of the printed multiple test pattern images is selected to determine or set the optimal reactive liquid amount.

### Printing of Test Pattern, Setting of Reactive Liquid Amount

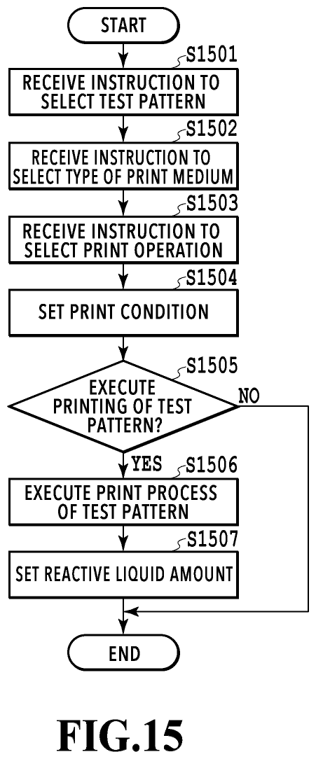

FIG. 15 is a flowchart of a reactive liquid amount setting process involving printing of the test pattern in the present embodiment.

In step S1501, the CPU 401 receives an instruction for selecting the test pattern to be printed, from the user. The instruction received in the present step is, for example, an instruction for selecting one of FIGS. 12A to 12D. Note that processes of steps after S1501 are the same as S1401 to S1406 of the first embodiment, respectively (see FIG. 14).

In S1502, the CPU 401 receives the instruction for selecting the type of print medium corresponding to the print medium that is not registered in advance, from the user. The present step is a process similar to that in the first embodiment (S1401 of FIG. 14).

In S1503, the CPU 401 receives the instruction to select the print operation. The present step is a process similar to that in the first embodiment (S1402 of FIG. 14). Moreover, explanation is given hereinafter by using a case where the CPU 401 receives an instruction to select “12-pass print A” focusing on image quality in the present step for the sake of convenience. This case is different from the case described in the first embodiment.

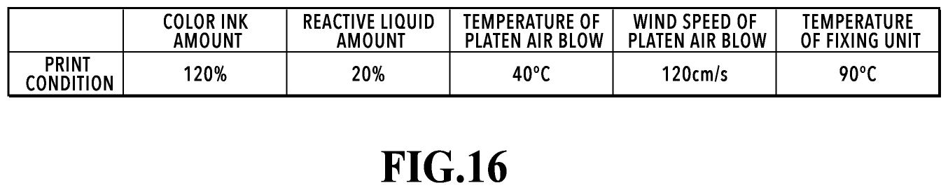

In S1504, the CPU 401 sets the print condition for the type of print medium indicated by the instruction received in S1502 and the print operation indicated by the instruction received in S1503. Specifically, for example, the CPU 401 sets values based on the initial setting values (see FIG. 16) of the respective parameters corresponding to the combination of “vinyl chloride film” and “12-pass print A”. In detail, the initial setting values may be set as they are as the print condition, or values adjusted from the initial setting values to be values suitable for an output image as necessary may be set as the print condition. Note that, hereinafter, it is assumed that the initial setting values illustrated in FIG. 16 are set as they are as the print condition in the present step for the sake of convenience. Moreover, the setting of the present step may be automatically performed or selectively performed based on an instruction from the user.

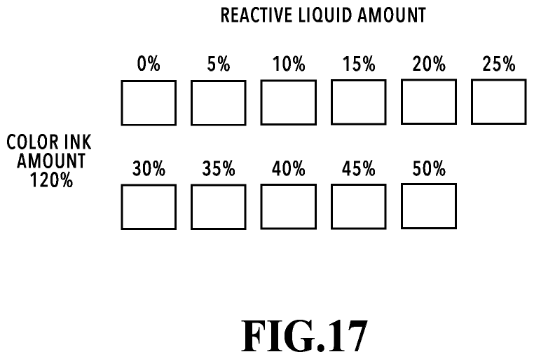

In S1505, the CPU 401 determines whether to execute printing of the test pattern (for example, see FIG. 17) selected in S1501 on the print medium of the type selected in S1502 based on the print operation selected in S1503 and the print condition set in S1504. For example, assume that there is a button configured to be pressed by the user in the case of instructing start of printing of the test pattern. In the case where the CPU 401 receives pressing of this button, the CPU 401 may determine YES in the present step. In the case where the determination result of the present step is YES, the process proceeds to S1506. Meanwhile, in the case where the determination result of the present step is NO, the series of processes is terminated.

In S1506, the CPU 401 executes the print process of printing the test pattern selected in S1501 on the print medium of the type selected in S1502 based on the print operation selected in S1503 and the print condition set in S1504. Note that, regarding the reactive liquid amount printed in the case where the print process is executed in the present step, values in a predetermined range that differ from one another at intervals of a predetermined value are used instead of the setting value (see FIG. 11) in the print condition as in the first embodiment. Such values include, for example, values from 0% to 50% that differ from one another at intervals of 5% (see FIG. 17).

In S1507, the CPU 401 sets the reactive liquid amount based on an instruction received from the user. The instruction received in the present step is an instruction in which the user has selectively determined the reactive liquid amount at which an image defect is most suppressed by visually recognizing the image (see FIG. 17, the image is one of the images of FIGS. 12A to 12D) for each of the reactive liquid amounts. Specifically, for example, in the case where 30% is superior to 20% that is the initial setting value from the viewpoint of bleeding suppression, the user determines 30% as the reactive liquid amount. This causes 30% to be set as the reactive liquid amount in the print condition for the combination of “vinyl chloride film” and “12-pass print A”.

As explained above, in the present embodiment, unlike in the first embodiment, the test pattern is first selected for the print medium that is not registered in advance.

In such a configuration, the reactive liquid amount that is for the predetermined color ink amount and at which an image defect is suppressed can be appropriately set.

### THIRD EMBODIMENT

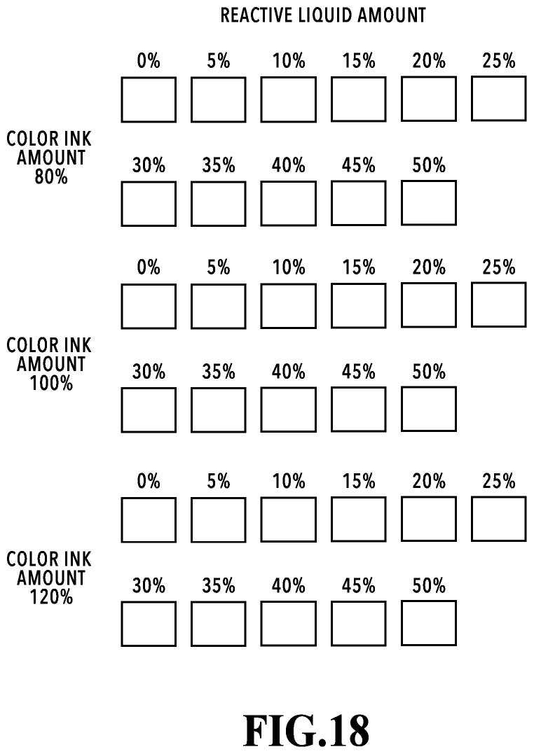

In a third embodiment, test patterns printed at different application amounts of the reactive liquid amount are printed for each of multiple color ink amounts (see FIG. 18).

FIG. 18 illustrates an arrangement diagram of the test patterns in the present embodiment, and in the present example, 11 images that are the images illustrated in FIG. 12D and that are different from one another in the reactive liquid amount are arranged for each of three types of color ink amounts of 80%, 100%, and 120%. Specifically, images printed at different application amounts of the reactive liquid amount from 0% to 50% at intervals of 5% are arranged for each of the three types of color ink amounts of 80%, 100%, and 120%.

### Printing of Test Pattern, Setting of Reactive Liquid Amount

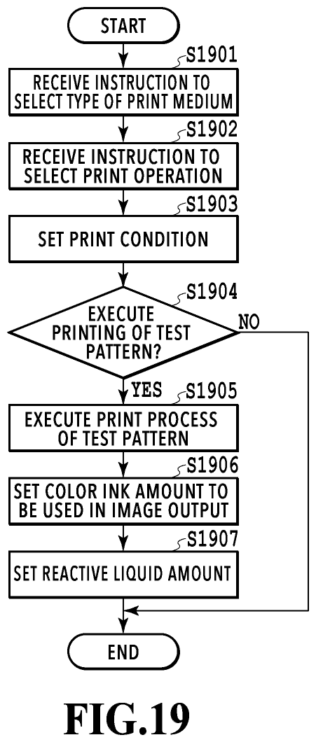

FIG. 19 is a flowchart of a reactive liquid amount setting process involving printing of the test patterns in the present embodiment.

In step S1901, the CPU 401 receives an instruction for selecting the type of print medium corresponding to the print medium that is not registered in advance, from the user. The present step is a process similar to that in the first embodiment (S1401 of FIG. 14). Note that explanation is given hereinafter by using a case where the CPU 401 receives an instruction to select “PP film” in the present step for the sake of convenience.

In S1902, the CPU 401 receives the instruction to select the print operation. The present step is a process similar to that in the first embodiment (S1402 of FIG. 14). Moreover, explanation is given hereinafter by using a case where the CPU 401 receives an instruction to select “8-pass print A” focusing on both of productivity and image quality in the present step for the sake of convenience. This case is different from the case described in the first embodiment or the second embodiment.

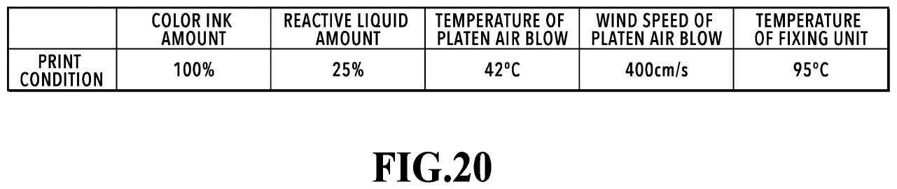

In S1903, the CPU 401 sets the print condition for the type of print medium indicated by the instruction received in S1901 and the print operation indicated by the instruction received in S1902. Specifically, for example, the CPU 401 sets values based on the initial setting values (see FIG. 20) of the respective parameters corresponding to the combination of “PP film” and “8-pass print A”. In detail, the initial setting values may be set as they are as the print condition, or values adjusted from the initial setting values to be values suitable for an output image as necessary may be set as the print condition. Note that the initial setting values illustrated in FIG. 20 are setting values for a print medium with high wettability. Moreover, hereinafter, it is assumed that the initial setting values illustrated in FIG. 20 are set as they are as the print condition in the present step for the sake of convenience. Moreover, the setting of the present step may be automatically performed or selectively performed based on an instruction from the user.

In S1904, the CPU 401 determines whether to execute printing of the predetermined test patterns (for example, see FIG. 18) on the print medium of the type selected in S1901 based on the print operation selected in S1902 and the print condition set in S1903. For example, assume that there is a button configured to be pressed by the user in the case of instructing start of printing of the test patterns. In the case where the CPU 401 receives pressing of this button, the CPU 401 may determine YES in the present step. In the case where the determination result of the present step is YES, the process proceeds to S1905. Meanwhile, in the case where the determination result of the present step is NO, the series of processes is terminated.

In S1905, the CPU 401 executes a print process of printing the predetermined test patterns (for example, see FIG. 18) on the print medium of the type selected in S1901 based on the print operation selected in S1902 and the print condition set in S1903. Note that, regarding the color ink amount and the reactive liquid amount printed in the case where the print process is executed in the present step, values that differ from one another at intervals of a predetermined value are used instead of the initial setting values (see FIG. 11). Such values of the color ink amount include, for example, 80%, 100%, and 120% that differ from one another at intervals of 20%. Such values of the reactive liquid amount include, for example, values from 0 to 50% that differ from one another at intervals of 5% (see FIG. 18). Note that the values do not have to differ from one another at equal intervals.

In S1906, the CPU 401 sets the color ink amount based on an instruction received from the user. The instruction received in the present step is an instruction from the user visually recognizing the test patterns printed in S1905, and is an instruction for determining an appropriate color ink amount from a viewpoint focusing on color reproduction property in which the color ink amount is large, a viewpoint focusing on reduction of ink consumption amount in which the color ink amount is small, or the like. Note that, hereinafter, the color ink amount is assumed to be set to 80% in the present steps from the viewpoint focusing on reduction of ink consumption amount for the sake of convenience.

In S1907, the CPU 401 sets the reactive liquid amount based on an instruction received from the user. The instruction received in the present step is an instruction in which the user has selectively determined the reactive liquid amount at which an image defect is most suppressed by visually recognizing each of the images of FIGS. 12A to 12C (see FIG. 18) for each of the reactive liquid amounts. Specifically, for example, in the case where 20% is superior to 25% that is the initial setting value from a viewpoint of bleeding suppression, the user determines 20% as the reactive liquid amount. This causes 20% to be set as the reactive liquid amount in the print condition for the combination of the color ink amount of 80%, “vinyl chloride film”, and “12-pass print A”.

As explained above, in the present embodiment, the test patterns printed at different application amounts of the reactive liquid amount are printed for each of the multiple color ink amounts to enable execution of setting of the color ink amount and setting of the reactive liquid amount simultaneously as setting of the print condition preferable from various viewpoints.

In such a configuration, the color ink amount and the reactive liquid amount at which an image defect is suppressed can be simultaneously set.

### OTHER EMBODIMENTS

In the case where each of the test patterns in FIGS. 13, 17, and 18 explained in the above-mentioned embodiments is printed, information on the type of print medium, the print operation, and the print condition may be printed on the print medium together with the printed test pattern to be associated with the printed test pattern. Moreover, although the case where the mask pattern A is used as illustrated in FIG. 10 is explained as the print operation, the print operation is not limited to this print operation. The configuration may be such that the mask pattern A or the mask pattern B illustrated in FIG. 6 can be selected depending on the type of print medium. Note that the mask pattern B is a mask patten for performing a print operation in which the color inks and the reactive liquid are printed in an identical print scanning operation.

Although a form in which the test pattern is selected before the selection of the type of print medium is explained in the second embodiment (see S1501 and S1502 in FIG. 15), the present disclosure is not limited to this form. Specifically, the timing of test pattern selection may be executed, for example, after one of S1502, S1503, or S1504.

Although the form in which the reactive liquid amount for the print medium that is not registered in advance is set is explained in the above-mentioned embodiments, the present disclosure is not limited to this form, and can be applied also to a form in which the reactive liquid amount for the print medium registered in advance is set. Moreover, explanation is given of a form in which: the temperature of the platen air blow can be set in the range of 35° C. or more to 45° C. or less; the wind speed of the platen air blow can be set in the range of 100 cm/sec or more to 500 cm/sec or less; and the platen air blow is set to ON. However, the present disclosure can be applied also to a form in which the platen air blow is set to OFF.

In the above-mentioned embodiments, explanation is given of the form in which the four types of inks of the black ink, the cyan ink, the magenta ink, and the yellow ink are ejected from the print head 105 as the color inks. However, the color inks used in the present disclosure are not limited to these. For example, the present disclosure can be applied also to a form in which a print operation using five types of color inks which are a white ink in addition to the above-mentioned four types of inks is executed on a transparent print medium, a colored print medium, or the like. Moreover, in this form, the print operation may be executed with the test pattern switched from the above-mentioned test pattern to a test pattern in which an image of a white ink is added to the images of FIGS. 12A to 12C.

In the above-mentioned embodiments, explanation is given of the form in which setting of the type of print medium, setting of the print operation, setting of the print condition, generation of image data of the test pattern, print execution based on the generated image data, and setting of the reactive liquid amount are executed on the main body side of the printing apparatus 100. However, the present disclosure is not limited to this form. It is possible to apply the technique of the present disclosure to a form in which the above operations are executed on the host apparatus 404 side (information processing apparatus side) connected to the printing apparatus 100 and obtain effects similar to those described above.

Moreover, the form in which, in the case where the user selects the type of print medium and the like and sets the print condition, the user performs the selection and the setting through the GUI window is described in the above-mentioned embodiments. However, the user interface (hereinafter, UI) is not limited to the GUI. The present disclosure can be applied also to a form in which the user uses an UI such as voice input to perform input for selecting or setting arbitrary items.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to achieve application amount correction of the reactive liquid taking the relevance between the type of print medium and the print condition into consideration.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033841, filed Mar. 4, 2025, which is hereby incorporated by reference wherein in its entirety.

What is claimed is:

1. An inkjet printing apparatus comprising:
a printing unit configured to print an image by applying a color ink and a reactive liquid to a print medium; and
a first setting unit configured to set a reactive liquid amount for a predetermined amount of the color ink, wherein
the printing unit prints a test pattern used to set the reactive liquid amount in the first setting unit, on the print medium of a type selected by a user, based on a print condition set by the user, and
a plurality of images formed by overlapping images of the color ink and images of the reactive liquid one on top of another are arranged in the test pattern, and the reactive liquid amounts for the respective plurality of images are a plurality of different values for an identical value of a color ink amount.

2. The inkjet printing apparatus according to claim 1, wherein the color ink amounts for the respective plurality of images are an identical value.

3. The inkjet printing apparatus according to claim 1, wherein
the print condition is a condition in a case where a selected print operation for the selected type is executed, and
the printing unit prints the test pattern on the print medium of the selected type based on the selected print operation and the set print condition.

4. The inkjet printing apparatus according to claim 3, wherein
the selected print operation is one operation selected by the user from among a plurality of operations corresponding to the selected type, and
the print operation is defined by at least one of the number of print scanning operations used in multi-pass printing, a used mask pattern, and a used ink color.

5. The inkjet printing apparatus according to claim 4, further comprising:
a first receiving unit configured to receive a first instruction for selecting the type of the print medium from the user;
a second receiving unit configured to receive a second instruction for selecting the print operation for the selected type of the print medium from the user; and
a second setting unit configured to set the print condition for the selected type and the selected print operation.

6. The inkjet printing apparatus according to claim 5, wherein the plurality of images of the test pattern each include at least one of an image in which solid color images of different ink colors are adjacent to one another, an image of a uniform color, and a plurality of character images of black color that differ from one another in font size.

7. The inkjet printing apparatus according to claim 6, wherein one of the plurality of images arranged in the test pattern is selected by the user.

8. The inkjet printing apparatus according to claim 7, wherein the first instruction, the second instruction, a third instruction for setting in the first setting unit, and a fourth instruction for setting in the second setting unit are inputted via a user interface.

9. The inkjet printing apparatus according to claim 8, further comprising a receiving unit configured to receive an instruction to select the test pattern to be printed from among a plurality of test patterns.

10. The inkjet printing apparatus according to claim 9, wherein the color ink amounts for the respective plurality of images arranged in the test pattern are values different from one another at intervals of a predetermined value.

11. The inkjet printing apparatus according to claim 10, further comprising a setting unit configured to set the color ink amount to be used in image output.

12. The inkjet printing apparatus according to claim 11, wherein the user interface is a graphical user interface window displayed on a display unit.

13. The inkjet printing apparatus according to claim 12, further comprising the display unit.

14. The inkjet printing apparatus according to claim 13, wherein
the inkjet printing apparatus is connected to an information processing apparatus, and
the information processing apparatus includes the display unit.

15. The inkjet printing apparatus according to claim 14, wherein the print condition includes at least one of the color ink amount, the reactive liquid amount, a temperature of platen air blow, a wind speed of the platen air blow, and a temperature of a fixing unit.

16. The inkjet printing apparatus according to claim 15, wherein the printing unit prints information on the print condition in printing of the test pattern, in the test pattern.

17. The inkjet printing apparatus according to claim 16, wherein
the color ink includes a color material,
the reactive liquid does not include the color material, and causes coagulation of the color material in a case where the reactive liquid comes into contact with the color ink.

18. A control method of an inkjet printing apparatus, the control method comprising:
printing an image by applying a color ink and a reactive liquid to a print medium; and
setting a reactive liquid amount for a predetermined amount of the color ink, wherein
in the printing, a test pattern used to set the reactive liquid amount in the setting is printed on the print medium of a type selected by a user, based on a print condition set by the user, and
a plurality of images formed by overlapping images of the color ink and images of the reactive liquid one on top of another are arranged in the test pattern, and the reactive liquid amounts for the respective plurality of images are a plurality of different values for an identical value of a color ink amount.

19. A non-transitory computer readable storage medium storing a program that causes a computer to execute a control method of an inkjet printing apparatus, the control method comprising:
printing an image by applying a color ink and a reactive liquid to a print medium; and
setting a reactive liquid amount for a predetermined amount of the color ink, wherein
in the printing, a test pattern used to set the reactive liquid amount in the setting is printed on the print medium of a type selected by a user, based on a print condition set by the user, and
a plurality of images formed by overlapping images of the color ink and images of the reactive liquid one on top of another are arranged in the test pattern, and the reactive liquid amounts for the respective plurality of images are a plurality of different values for an identical value of a color ink amount.
